(19) United States
(12) Patent Application Publication
(10) Pub. No.: US 2020/0141540 A1
(43) Pub. Date: May 7, 2020

(54) METHOD FOR LEAKAGE-PROOF STORAGE OF LIQUEFIED CHLORINE

(71) Applicant: Covestro Deutschland AG, Leverkusen (DE)

(72) Inventors: Andreas BULAN, Langenfeld (DE); Rainer WEBER, Odenthal (DE); Jürgen KINTRUP, Leverkusen (DE); Daniel Gordon DUFF, Leverkusen (DE); Verena HAVERKAMP, Bergisch Gladbach (DE); Giulio LOLLI, Köln (DE); Jose FONSECA, Leverkusen (DE); Stefanie EIDEN, Köln (DE); Thomas KÖNIG, Leverkusen (DE)

(73) Assignee: Covestro Deutschland AG, Leverkusen (DE)

(21) Appl. No.: 16/632,017

(22) PCT Filed: Jul. 16, 2018
(86) PCT No.: PCT/EP2018/069202

§ 371 Date: Jan. 17, 2020

(30) Foreign Application Priority Data
Jul. 21, 2017 (EP) 17182482.4

(51) Int. Cl. F17C 5/02

(52) U.S. Cl. CPC F17C 5/02; F17C 2221/03; F17C 2260/044; F17C 2225/033; F17C 2260/036; F17C 2223/0153

(57) ABSTRACT

The invention relates to a method for the leakage-proof storage of liquefied chlorine under increased pressure in pressure tanks, in which up to 20 wt. % polyvinyl chloride (PVC) or chlorinated polyvinyl chloride (cPVC) is placed in the pressure tank prior to filling the pressure tank with liquefied chlorine.

The invention relates to the leakproof storage of liquefied chlorine in pressure tanks under increased pressure, the purpose being to avoid or reduce the escape of chlorine in the event of leaks from the pressure tank.

As the prior art, US5788743A1 describes inter alia some solvents for chlorine, but no macromolecular solvents. Polymer solutions in liquid chlorine are already known. For example, U.S. Pat. No. 4,459,387 describes a process for the photochlorination of polyvinyl chloride (PVC) in which the PVC granules swell in the liquefied chlorine, resulting in the formation of a gel. The chlorine reacts here with the PVC, forming CPVC (chlorinated PVC). However, the solution thus formed (whether PVC in chlorine or CPVC in chlorine) is not described as a potential form of storage for chlorine. Moreover, AIChE-Journal 34 (1988) 1683-1690 and J. Polym. Sci. Part B: Polymer Physics 38 (2000) 3201-3209 describe inter alia the diffusion of chlorine in cPVC. U.S. Pat. No. 8,343,261 describes the storage of methane in metal-organic frameworks (MOFs) and U.S. Pat. No. 5,518,528 describes the use of sorbents for improved safety during the transport and storage of hazardous gases. The two uses both describe a sorptive interaction, rather than mutual molecular dissolution of the components in one another. An alternative to MOFs are so-called POPs (porous organic polymers). A POP functionalized with chlorine shows a strongly selective, sorptive interaction with CO₂ by comparison with CH₄ (J. Mater. Chem. 2012, 22, 13524), but there is no mention at all in the article of a possible interaction of the POP with chlorine gas (or with liquid Cl₂ either).

In the prior art, chlorine is stored either at low pressures and low temperatures in the region of −34° C., or at high pressures in the region of 4-10 bar and ambient temperatures [Euro Chlor (2002), Guideline “Technical and safety aspects for chlorine producers and users” GEST 73/17 6th Edition, November 2002, “Low Pressure Storage of Liquid Chlorine”; Euro Chlor (2002), Guideline “Technical and safety aspects for chlorine producers and users” GEST 72/10, 9th Edition, September 2002, “Pressure Storage of Liquid Chlorine” ].

For low-pressure storage, chlorine must be cooled to low temperature and then transferred to storage tanks as liquid chlorine.

For pressure storage, chlorine must be liquefied by compression and then transferred to storage tanks.

Euro Chlor recommends a maximum storage capacity for individual tanks of 300-400 t, which corresponds to 200-270 m³ in pressure storage [Ullmann's Encyclopedia of Industrial Chemistry (2011), 7th Edition, “Chlorine”, 8 (12), p. 604].

The disadvantage of both storage modes is that large amounts of chlorine can quickly escape into the environment in the event of a loss of storage container integrity, which means that elaborate safety measures are necessary to avoid this. The amount of chlorine stored by chlorine producers is accordingly kept as low as possible, which in turn means that no major chlorine reserves are available.

The object of the invention is to allow a safe storage of chlorine that, in particular, avoids or reduces leakage from chlorine tanks and the escape of chlorine from the pressure tank.

The object is achieved according to the invention by filling the pressure tank with PVC or cPVC prior to filling with liquefied chlorine, with the ability to seal the leak in the event of leakage from the pressure tank.

The subject of the invention is a method for the leakproof storage of liquefied chlorine under increased pressure in pressure vessels, characterized in that the pressure vessel is charged with up to 20% by weight of polyvinyl chloride (PVC) or chlorinated polyvinyl chloride (cPVC) before the filling of the pressure vessel with liquefied chlorine.

Preference is given to an embodiment of the method according to the invention characterized in that the pressure vessel is charged with from 1 to 20% by weight of PVC or cPVC, more preferably from 2 to 18% by weight of PVC.

Preference is given to an embodiment of the method characterized in that the molecular weight M. of the PVC or cPVC is from 20 000 to 250 000, more preferably from 25 000 to 200 000.

In a further preferred embodiment of the new method, the pressure in the pressure vessel after pressurizing with chlorine is from 2 to 15 bar (2000 to 15 000 hPa).

### EXAMPLE FOR PVC/CPVC

The measurements were performed in an assembly for the measurement of phase equilibria. The assembly comprises a high-pressure view cell, pumps for filling the view cell with chlorine, and a vacuum vessel. The high-pressure view cell consists of a sapphire glass cylinder and stainless steel flanges (material stainless steel 316, volume 325 cm³, maximum pressure: 10 MPa).

The temperature is measured by a calibrated Pt-100 platinum resistance thermometer and the pressure by a calibrated precision pressure transmitter (Keller PA-25 HTC), which is directly coupled to the cell. Compressed chlorine is added by means of a screw pump (Sitec). The upper flange of the view cell is provided with openings, through which it is possible to simulate a sudden fall in pressure in the vessel by operating a valve.

For this, the high-pressure view cell is connected, via the valve, to a vacuum vessel (volume 20 L) in which the escaping gas is collected.

During each experiment, the pressure and temperature in the vacuum vessel, the pressure and temperature in the high-pressure view cell, and the time taken to reach a pressure of 1 bar abs. in the vacuum vessel were measured.

### Example 1: Chlorine Release from Liquid Chlorine

For this example, liquid chlorine (Linde, 99.999%) was added to the cell until the level of the liquid chlorine was about 2 centimeters. The pressure in the cell was equal to the vapor pressure of chlorine: 7.1 bar at 22° C. The pressure in the cell was then released abruptly against vacuum by opening a valve. The valve was closed once the pressure in the vacuum vessel had reached 1 bar abs. The time taken to reach this pressure was 69 s.

### Example 2: Chlorine Release from a Mixture of Chlorine and cPVC (13% by Weight)

In a first step, the high-pressure view cell was charged with 48 g of polyvinyl chloride, PVC (Aldrich Chemistry, product number 189588-1 kg, having a number-average molecular weight Mn of 35 000). Liquid chlorine (Linde, 99.990%) was added to a pressure of 7.1 bar abs. and a temperature of 22° C., so as to form a liquid PVC/chlorine solution. The resulting proportion of PVC in the solution was 13% by weight. After addition of the chlorine, the PVC is first converted to cPVC with liberation of HCl. The cell was accordingly allowed to stand for a period of 2 h and the HCl evolved released from the cell.

The pressure in the vessel was then released abruptly against vacuum by opening a valve. This released chlorine to an end pressure in the vacuum vessel of 1 bar abs. On opening, a froth developed that rose to a height of several centimeters and persisted even after closing the valve.

The time taken to reach the pressure of 1 bar abs. in the vacuum vessel was 145 s.

### Example 3: Chlorine Release from a Mixture of Chlorine and cPVC (16% by Weight)

The cell was again charged with polyvinyl chloride and chlorine added until the proportion of PVC in the solution was 16% by weight. After addition of the chlorine, the PVC is first converted to cPVC with liberation of HCl. The cell was accordingly allowed to stand for a period of 2 h and the HCl evolved released from the cell.

The pressure in the vessel was then released abruptly against vacuum by opening a valve. This released chlorine to an end pressure in the vacuum vessel of 1 bar abs.

On opening, a froth developed that rose to a height of several centimeters and persisted even after closing the valve.

The time taken to reach the pressure of 1 bar abs. in the vacuum vessel was 179 s.

Examples 2 and 3 show a slowing of chlorine release by a factor of 2-2.5 relative to example 1.

1.-4. (canceled)

5. A method for the leakproof storage of liquefied chlorine under increased pressure in pressure vessels, comprising charging the pressure vessel with up to 20% by weight of polyvinyl chloride (PVC) or chlorinated polyvinyl chloride (cPVC) before the filling the pressure vessel with liquefied chlorine.

6. The method as claimed in claim 5, wherein the pressure vessel is charged with from 1 to 20% by weight of PVC or cPVC.

7. The method as claimed in claim 5, wherein the molecular weight Mn of the PVC or cPVC is from 20 000 to 250 000.

8. The method as claimed in claim 5, wherein the pressure in the pressure vessel after pressurizing with chlorine is 2 to 15 bar.
